(19) United States
(12) Patent Application Publication
(10) Pub. No.: US 2023/0247555 A1
(43) Pub. Date: Aug. 3, 2023

(54) WAKE-UP SIGNALS IN CELLULAR SYSTEMS

(71) Applicant: TCL COMMUNICATION (NINGBO) CO., LTD., Ningbo, Zhejiang (CN)

(72) Inventor: Sebastian WAGNER, Ningbo, Zhejiang (CN)

(73) Assignee: TCL COMMUNICATION (NINGBO) CO., LTD., Ningbo, Zhejiang (CN)

(21) Appl. No.: 18/004,285

(22) PCT Filed: Jul. 8, 2021
(86) PCT No.: PCT/CN2021/105309

§ 371 Date: Jan. 4, 2023

Related U.S. Application Data
(60) Provisional application No. 63/049,603, filed on Jul. 8, 2020.

(51) Int. Cl. H04W 52/02; H04W 68/00

(52) U.S. Cl. CPC H04W 52/0235; H04W 68/005

(57) ABSTRACT

A method of transmitting a wake-up signal from a base station to a user equipment (UE) in a cellular communications system is disclosed. The base station is configured to transmit a plurality of beams. The method includes transmitting a burst of wake up signals, and the burst of wake up signals includes at least one wake up signal transmitted on each beam.

### TECHNICAL FIELD

The following disclosure relates to the transmission of wake-up signals in cellular networks, and in particular to the transmission of such signals in a beam-sweeping system.

### BACKGROUND

Wireless communication systems, such as the third-generation (3G) of mobile telephone standards and technology are well known. Such 3G standards and technology have been developed by the Third Generation Partnership Project (3GPP) (RTM). The 3rd generation of wireless communications has generally been developed to support macro-cell mobile phone communications. Communication systems and networks have developed towards a broadband and mobile system.

In cellular wireless communication systems User Equipment (UE) is connected by a wireless link to a Radio Access Network (RAN). The RAN comprises a set of base stations which provide wireless links to the UEs located in cells covered by the base station, and an interface to a Core Network (CN) which provides overall network control. As will be appreciated the RAN and CN each conduct respective functions in relation to the overall network. For convenience the term cellular network will be used to refer to the combined RAN & CN, and it will be understood that the term is used to refer to the respective system for performing the disclosed function.

The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB. NR is proposed to utilise an Orthogonal Frequency Division Multiplexed (OFDM) physical transmission format.

The NR protocols are intended to offer options for operating in unlicensed radio bands, to be known as NR-U. When operating in an unlicensed radio band the gNB and UE must compete with other devices for physical medium/resource access. For example, Wi-Fi (RTM), NR-U, and LAA may utilise the same physical resources.

A trend in wireless communications is towards the provision of lower latency and higher reliability services. For example, NR is intended to support Ultra-reliable and low-latency communications (URLLC) and massive Machine-Type Communications (mMTC) are intended to provide low latency and high reliability for small packet sizes (typically 32 bytes). A user-plane latency of 1 ms has been proposed with a reliability of 99.99999%, and at the physical layer a packet loss rate of 10⁻⁵ or 10⁻⁶ has been proposed.

mMTC services are intended to support a large number of devices over a long life-time with highly energy efficient communication channels, where transmission of data to and from each device occurs sporadically and infrequently. For example, a cell may be expected to support many thousands of devices.

The disclosure below relates to various improvements to cellular wireless communications systems.

### SUMMARY

There is provided a method of transmitting a wake-up signal from a base station to a UE in a cellular communications system, wherein the base station transmits a plurality of beams, the method comprising transmitting a burst of wake up signals, the burst comprising at least one wake up signal transmitted on each beam.

The wake up signal burst may be transmitted a predefined time offset prior to a paging occasion to which the wake up signal burst relates.

The time offset may be defined as the time from the end of the wake up signal burst to the start of a paging occasion to which the wake up signal burst relates.

At least two of the wake up signals of the burst may be transmitted continuously in adjacent symbols.

The wake up signals may be frequency multiplexed with SS/PBCH, SIB1, or PDCCH signals.

The wake up signals of at least two beams may be the same.

The wake up signals of at least two beams may be different.

The at least one wake up signal may comprise a base sequence with a cyclic shift dependent on the beam.

The burst of wake up signals may be transmitted in at least two slots.

The burst of wake signals may not overlap with control regions of slots in which the burst of wake signals is transmitted.

There is also provided a base station configured to perform the methods described herein.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 shows selected elements of a cellular communications system;

FIG. 2 shows an example burst of WUS;

FIG. 3 shows an example burst of WUS and associated paging occasion;

FIGS. 4 to 6 show examples of WUS multiplexed with SS/PBCH; and

FIGS. 7 to 9 show examples of WUS multiplexed with SIB1 and other signals.

### DETAILED DESCRIPTION OF THE PREFERRED EMBODIMENTS

Those skilled in the art will recognise and appreciate that the specifics of the examples described are merely illustrative of some embodiments and that the teachings set forth herein are applicable in a variety of alternative settings.

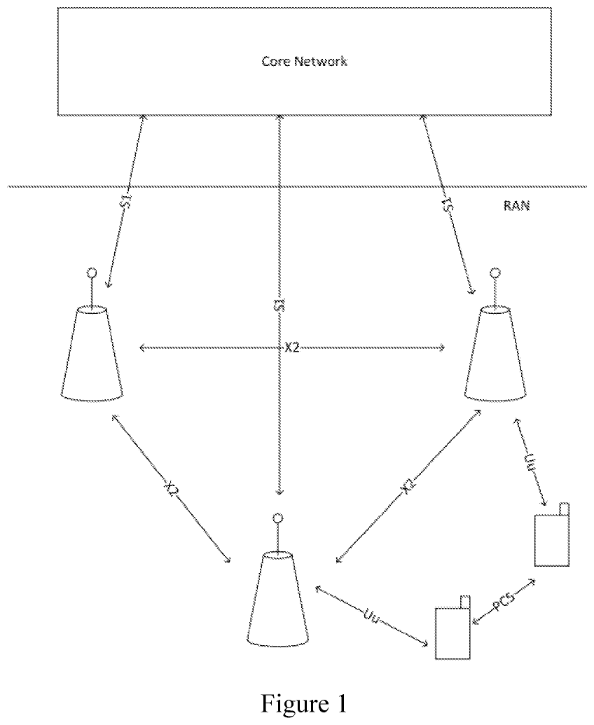

FIG. 1 shows a schematic diagram of three base stations (for example, eNB or gNBs depending on the particular cellular standard and terminology) forming a cellular network. Typically, each of the base stations will be deployed by one cellular network operator to provide geographic coverage for UEs in the area. The base stations form a Radio Area Network (RAN). Each base station provides wireless coverage for UEs in its area or cell. The base stations are interconnected via the X2 interface and are connected to the core network via the 51 interface. As will be appreciated only basic details are shown for the purposes of exemplifying the key features of a cellular network. A PC5 interface is provided between UEs for SideLink (SL) communications. The interface and component names mentioned in relation to FIG. 1 are used for example only and different systems, operating to the same principles, may use different nomenclature.

The base stations each comprise hardware and software to implement the RAN's functionality, including communications with the core network and other base stations, carriage of control and data signals between the core network and UEs, and maintaining wireless communications with UEs associated with each base station. The core network comprises hardware and software to implement the network functionality, such as overall network management and control, and routing of calls and data.

For certain categories of device operating in cellular networks power consumption is a critical parameter. 3GPP have specified a Machine-Type Communication (MTC) UE type in LTE for the implementation of devices like industrial sensors expected to function for several years on a single battery charge. For static and nomadic devices (IoT) the NB-IoT standard may be utilised.

To reduce power consumption such devices may spend significant portions of time in RRC_IDLE/INACTIVE mode utilising discontinuous reception (DRX) to turn off their radio systems, only waking to listen for paging messages. Although paging occasions for the possible reception of paging messages are infrequent, the process of decoding a paging message is complex and consumes a relatively significant amount of power. For example, a UE must wake up prior to the expected Paging Occasion (PO), turn on RF and baseband systems, synchronise in time and frequency, and attempt to decode PDCCH for a paging DCI scrambled with P-RNTI. If no paging DCI is detected the UE can return to sleep (DRX). The process can take several frames, depending PDCCH repetition, and PDCCH decoding is relatively complex. In order to reduce this complexity a Wake-Up Signal (WUS) may be transmitted for detection by UEs prior to a paging occasion in which a paging message is to be transmitted to a UE. The WUS is typically sequence-based to enable easy detection without requiring decoding and baseband processing. UEs are configured to wake-up to detect the WUS, and if the UE's signal is detected the UE wakes up fully to receive the PDCCH at the appropriate time as it has confidence there is a paging message. If the WUS is not detected the UE can return to sleep. The reduced complexity of detecting the WUS (which may be performed using a correlator) reduces power consumption compared to performing a full PDCCH decode.

The DRX system utilises a DRX cycle within which one or more PO is defined. The DRX/paging cycle may be indicated in SIB1, or a UE-specific DRX cycle can be negotiated during NAS registration. Typically the paging cycle is 32, 64, 128, or 256 radio frames. The Paging Frame and Paging Occasion are defined in accordance with the relevant standards, for example, TS 38.304.

The WUS in RRC_IDLE/INACTIVE is principally used for power saving by low-power UEs and robust detection is important. Previous systems have sought to provide robustness using time-repetition and use of synchronisation signals required for time-frequency synchronisation before PDCCH detection. However, in NR synchronisation signals have a configurable periodicity, and beam-sweeping (particularly in FR2) requires that transmissions on each beam are short. Repetitions, or long WUS, lasting several milliseconds cannot be supported.

Set out in the following disclosure are techniques to provide an efficient WUS system, particularly for beam-sweeping systems operating at high frequencies.

MTC and NB-IoT devices support a bandwidth of 1.4 MHz, in comparison to REDCAP NR devices which are anticipated to support at least 20 MHz in FR1 and 50 to 100 MHz in FR2. These additional resources may be utilised for longer WUS sequences, or WUS repetition in the frequency-domain, rather than time-domain repetition.

In the following disclosure it is assumed that the WUS can be transmitted anywhere in the available time-frequency resources, can have any duration in terms of OFDM symbols, and the duration and the start or end of the WUS is known from pre-configuration.

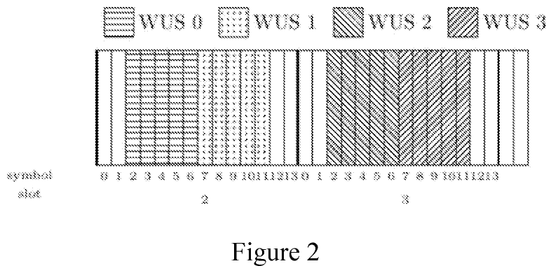

Since paging messages have to be transmitted on all beams, the associated WUS must also be transmitted on all beams. To achieve this a burst of transmissions of a WUS on each beam is utilised. FIG. 2 shows an example of such a burst transmission for 4 beams where the burst comprises at least one WUS for each beam (the WUS being the same on each beam). The WUS duration for each beam is kept short, 5 symbols in this example, to manage the time required for the beam-sweeping operation. The starting position for each WUS transmission (on each beam) may be specified by standard, or configured for each base station, for example using higher layer (RRC) signalling. The starting position of each WUS in a burst will depend on the duration of the WUS.

In general, one or more WUS may be transmitted on the resources indicated for WUS throughout this disclosure. For clarity of description only, references are made to WUS in the singular, but this does not exclude a plurality of WUS being transmitted.

In order to avoid conflict with PDCCH and PUCCH no WUS is transmitted in the first two or last two symbols of each slot. It may also be preferable not to transmit WUS in the middle of a slot to avoid conflict with PDCCH or PUCCH for URLLC transmissions.

The WUS transmission may be continuous in time with the base station switching beams during the transmission. However, this may not be possible for longer WUS while also avoiding the control transmissions at the start and end of each slot. As can be seen in FIG. 2 only two WUS can be transmitted continuously without overlapping the control transmissions at the start and end of the slots. Where WUS are transmitted continuously, only the start position and duration need to be defined.

FR1 in NR is intended to support up to 4 beams for carrier frequencies≤3 GHz and up to 8 beams between 3 GHz and 6 GHz.

Tables 1 and 2 below show possible starting positions for 15 kHz Sub-Carrier Spacing (SCS) for 4 and 9 beams respectively.

TABLE 1
Example of WUS starting positions for 15
kHz SCS and FR1 ≤ 3 GHz (up to 4 beams).

| duration | starting | |
|---|---|---|
| [symbols] | position | comment |
| 1 | 2, 3, 4, 5 | Full burst 1st half of slot |
| | 8, 9, 10, 11 | Full burst 2nd half of slot |
| | 2, 3, 8, 9 | Half burst in 1st/2nd half of slot |
| | 2, 5, 8, 11 | Equally spaced WUS in slot |
| | 2, 8, 16, 22 | FDM with SS/PBCH |
| 2 | 2, 4, 6, 8 | Continuous transmission |
| | 2, 8, 16, 11 | FDM with SS/PBCH |
| 3 | 2, 5, 8, 22 | Continuous transmission |
| | 2, 8, 16, 22 | FDM with SS/PBCH |
| 4 | 2, 8, 16, 22 | FDM with SS/PBCH |
| 10 | 2, 16, 30, 44 | Full slot WUS over 4 slots |

TABLE 2
Example of WUS starting positions for 15 kHz SCS and
FR1 > 3 GHz ≤ 6 GHz (up to 8 beams).

| duration | starting | |
|---|---|---|
| [symbols] | position | comment |
| 1 | 2, 3, 4, 5, 8, 9, 10, 11 | Full burst in one slot |
| | 2, 5, 8, 11, 16, 19, 22, 25 | Equally spaced WUS in 2 slots |
| | 2, 3, 4, 5, 6, 7, 8, 9 | Continuous transmission |
| | 2, 8, 16, 22, 30, 36, 44, 50 | FDM with SS/PBCH (4 slots) |
| 2 | 2, 8, 16, 22, 30, 36, 44, 50 | FDM with SS/PBCH |
| 3 | 2, 8, 16, 22, 30, 36, 44, 50 | FDM with SS/PBCH |
| 4 | 2, 8, 16, 22, 30, 36, 44, 50 | FDM with SS/PBCH |

Tables 3 and 4 show possible starting positions for 30 kHz SCS for 4 and 8 beams respectively.

TABLE 3
Example of WUS starting positions for 30
kHz SCS and FR1 ≤ 3 GHz (up to 4 beams).

| duration | starting | |
|---|---|---|
| [symbols] | position | comment |
| 1 | 2, 3, 4, 5 | Full burst 1st quarter of slot |
| | 8, 9, 10, 11 | Full burst 2nd quarter of slot |
| | 16, 17, 18, 19 | Full burst 3rd quarter of slot |
| | 22, 23, 24, 25 | Full burst 4th quarter of slot |
| | 2, 8, 16, 22 | FDM with SS/PBCH |
| 2 | 2, 4, 6, 8 | Continuous transmission |
| | 2, 8, 16, 22 | FDM with SS/PBCH |
| | 4, 6, 8, 10 | Continuous transmission |
| | 4, 8, 16, 20 | FDM with SS/PBCH |
| | 4, 10, 16, 22 | Equally spaced in subframe |
| 3 | 2, 8, 10, 22 | FDM with SS/PBCH |
| | 4, 8, 16, 20 | FDM with SS/PBCH |
| 4 | 2, 8, 16, 22 | FDM with SS/PBCH |
| | 4, 8, 10, 20 | FDM with SS/PBCH |

TABLE 4
Example of WUS starting positions for 30 kHz SCS and
FR1 > 3 GHz ≤ 6 GHz (up to 8 beams).

| duration | starting | |
|---|---|---|
| [symbols] | position | comment |
| 1 | 2, 3, 4, 5, 8, 9, 10, 11 | Full burst in slot |
| | 4, 5, 6, 7, 8, 9, 10, 11 | Full burst in slot |
| | 2, 3, 4, 5, 6, 7, 8, 9 | Continuous transmission |
| | 2, 8, 16, 22, 30, 36, 44, 50 | FDM with SS/PBCH |
| | 4, 8, 16, 20, 32, 36, 44, 48 | FDM with SS/PBCH |
| 2 | 2, 8, 16, 22, 30, 36, 44, 50 | FDM with SS/PBCH |
| | 4, 8, 16, 20, 32, 36, 44, 48 | FDM with SS/PBCH |
| | 4, 10, 16, 22, 28, 34, 40, 46 | Equally spaced in 2 subframes |
| 3 | 2, 8, 16, 22, 30, 36, 44, 50 | FDM with SS/PBCH |
| | 4, 8, 16, 20, 32, 36, 44, 48 | FDM with SS/PBCH |
| 4 | 2, 8, 16, 22, 30, 36, 44, 50 | FDM with SS/PBCH |
| | 4, 8, 16, 20, 32, 36, 44, 48 | FDM with SS/PBCH |

Tables 5 and 6 show possible starting positions for the 64 beams when operating in FR2 for 120 kHz and 240 kHz SCS respectively.

TABLE 5
Example of WUS starting positions for 120 kHz SCS and
FR2 > 6 GHz (up to 64 beams). 112 slots in subframe and
n = 0, 1, 2, 3, 5, 6, 7, 8, 10, 11, 12, 13, 15, 16, 17, 18.

| duration | starting | |
|---|---|---|
| [symbols] | position | comment |
| 1 | 4, 5, . . . , 66, 67 | Full burst in subframe |
| | {4, 8, 16, 20} + 28 × n | FDM with SS/PBCH |
| 2 | {4, 8, 16, 20} + 28 × n | FDM with SS/PBCH |
| 3 | {4, 8, 16, 20} + 28 × n | FDM with SS/PBCH |
| 4 | {4, 8, 16, 20} + 28 × n | FDM with SS/PBCH |

TABLE 6
Example of WUS starting positions for 240 kHz SCS and
FR2 > 6 GHz (up to 64 beams). 112 slots in subframe
and n = 0, 1, 2, 3, 5, 6, 7, 8.

| duration | starting | |
|---|---|---|
| [symbols] | position | comment |
| 1 | 4, 5, . . . , 66, 67 | Full burst in subframe |
| | {8, 12, 16, 20, 32, 36, 40, 44} + | FDM with SS/PBCH |
| | 56 × n | |
| 2 | {8, 12, 16, 20, 32, 36, 40, 44} + | FDM with SS/PBCH |
| | 56 × n | |
| 3 | {8, 12, 16, 20, 32, 36, 40, 44} + | FDM with SS/PBCH |
| | 56 × n | |
| 4 | {8, 12, 16, 20, 32, 36, 40, 44} + | FDM with SS/PBCH |
| | 56 × n | |

To simplify configuration and scheduling in the time domain, the WUS length may be limited, for example to either 1 or 4 symbols, and the coverage increased by extending/repeating the WUS in the frequency or time domain.

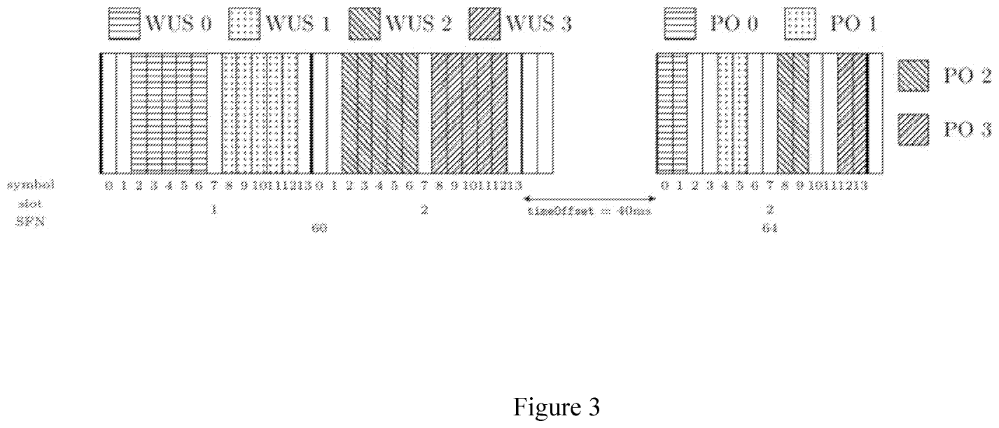

As shown in FIG. 3 the WUS burst is associated with a PO according to a defined time offset. In the example of FIG. 3 the PO occurs in SFN 64 and 4 PDCCH occasions are configured (one for each beam). In the example of FIG. 3 the time offset, which may be defined by higher layer configuration and signalling, is defined between the last slot of the WUS burst and the first slot of the PO (not between the WUS for a beam and the PDCCH monitoring occasion on that same beam). The PDCCH for each PO is configured via a search space and an associated CORESET. The WUS has its own duration which may be longer than the CORESET duration for the associated PDCCH. Hence, applying the same timeOffset per beam may not be possible because of the different durations/configuration of the signals, hence defining the delay based on the burst timing is attractive. The time offset may be defined as an absolute time in milliseconds, or another convenient set of units.

Table 7 shows possible configurations of SSB periodicity and example values for the time offset between the end of the WUS burst and the start of the PO.

TABLE 7
Example of possible values of timeOffset.

| | |
|---|---|
| ssbPeriodicity [ms] | 5, 10, 20, 40, 80, 160 |
| timeOffset [ms] | 5, 10, 20, 40, 80, 160, 320 |

The shorter offsets of 5 and 10 ms may be beneficial where the WUS is frequency multiplexed with the SS/PBCH transmission (as discussed below) in which case the UE would detect WUS and SS/PBCH at the same time and be ready to decode a paging message soon after. In general, the time offset should be defined such that at last one SSB occasion occurs between the WUS and the PO such that the UE can synchronise with, and confirm, the serving cell.

In order to avoid a specific beam-sweep to transmit the WUS the WUS may be multiplexed with other signals which need to be transmitted. Cell-wide signals, for example SS/PBCH or Type 0 common search space for SIB1, may be particularly appropriate for multiplexing. A particular multiplexing arrangement may be configured via higher layer signalling, for example RRC.

Frequency multiplexing, for example with SS/PBCH, may be most beneficial when both signals are of the same length, but the principles may still be applied when the lengths are different. It is preferable that the SCS of the multiplexed transmissions is the same to avoid gaps in frequency usage.

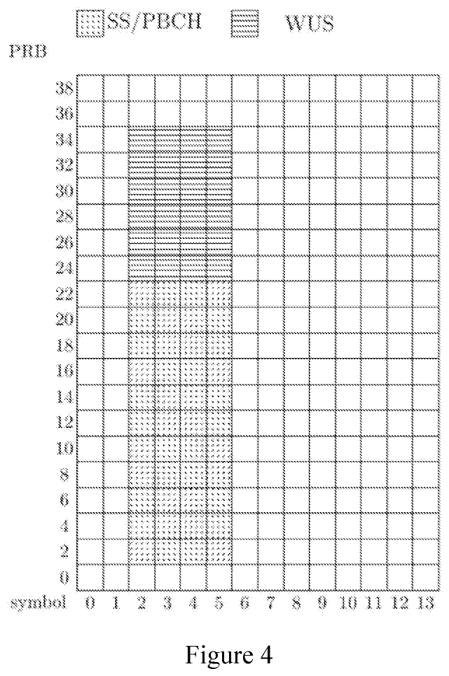

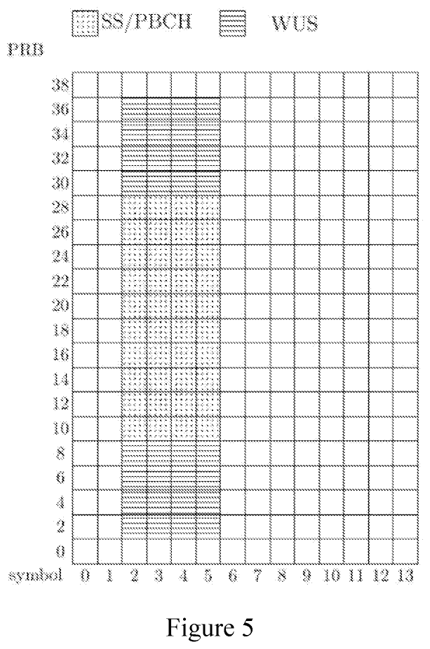

FIGS. 4 & 5 show examples of a 4-symbol WUS frequency multiplexed with a 4-symbol SS/PBCH. The particular multiplexing arrangement can be selected based on available resources and the arrangements of the figures are shown as examples only.

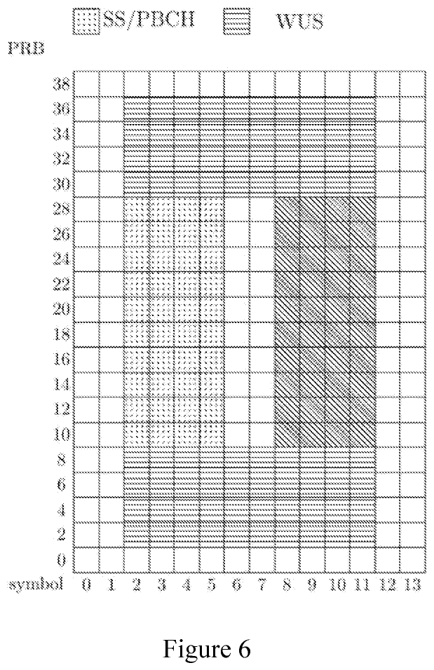

In the example of FIG. 6 two SS/PBCH from a burst are shown, each transmitted on a different beam. WUS is multiplexed with both transmissions, and transmission of WUS also continues between the transmissions. The base station may select any direction for the intervening transmission to optimise performance. If the intervening time would interfere with a search space for control signalling the base station may not make any transmission and pause WUS transmission until the next SS/PBCH symbols.

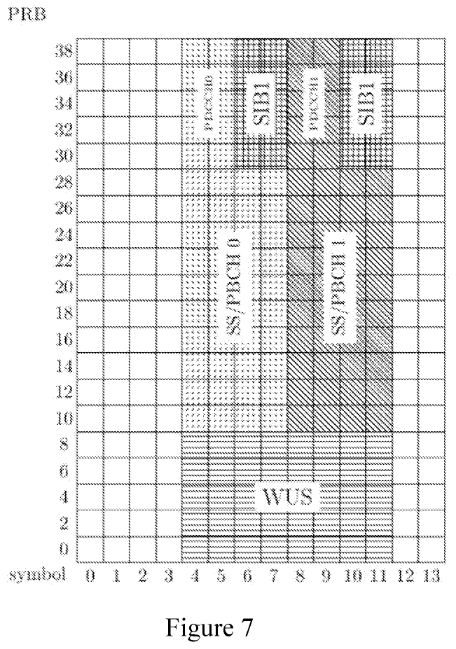

FIG. 7 shows an example of WUS multiplexed with SS/PBCH in FR2 with multiplexing pattern 3, where the paging search space is configured the same as searchSpaceZero.

If the WUS is frequency multiplexed with the SS/PBCH the time offset discussed above describes the offset as multiples of the SSB periodicity. The time offset is thus the time between the start of the WUS burst and the start of the first PDCCH monitoring occasion of the relevant PO. For example, if SSB periodicity is 20 ms, and the time offset is 80 ms, WUS is transmitted with SS/PBCH 8 frames before the relevant PO.

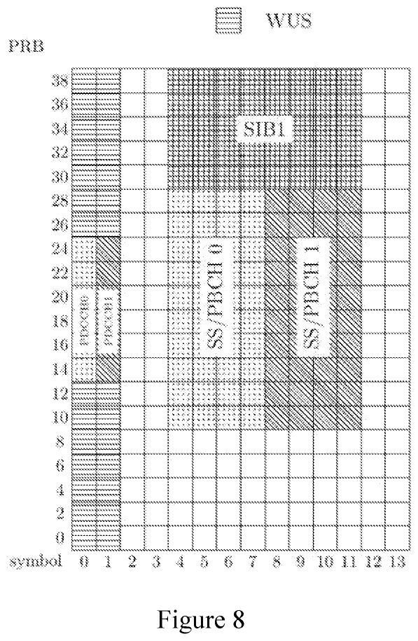

In a specific example for FR2 with multiplexing pattern 2 and a paging search space which is the same as searchSpaceZero, WUS may be multiplexed with CSS0 since PDCCH is time-interleaved with the SS/PBCH/SIB1 transmission. This approach may be preferable if there are insufficient resources to multiplex WUS with SS/PBCH due to the multiplexing of SS/PBCH with SIB 1. FIG. 8 shows an example of multiplexing pattern 2 with an SCS of 120 kHz for all signals. This multiplexing pattern specifies one symbol for PDCCH, but depending on the SCS configuration of the PDCCH and the WUS, a WUS with either one or two symbol duration can be frequency multiplexed with the PDCCH. FIG. 8 shows an example with 2 beams.

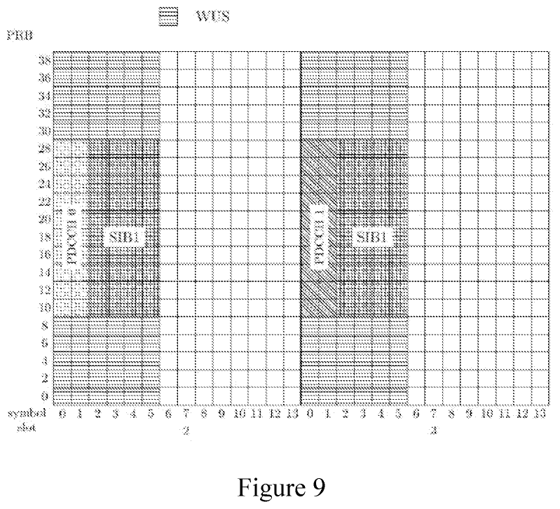

WUS may also be frequency multiplexed with SIB1 or Type0 CSS and SIB 1. FIG. 9 shows an example of WUS frequency multiplexed with Type0 CSS and SIB1 for multiplexing pattern 1 with the search space starting at slot 2. Only 2 beams are shown for clarity.

As with the above examples, the definition of the time offset will depend on the WUS multiplexing scheme employed. In this example the time offset is the duration between the PO and Type0 CSS/SIB1 occasion with which the relevant WUS is multiplexed.

In the above discussion the WUS is the same for each beam. However, the WUS may be beam-specific such that the signal indicates the beam on which it is transmitted. That is, the WUS may encode the beam index. This allows the UE to determine which beams have the best reception from detection of the WUS and can hence optimise SS/PBCH detection from the most well-received beam(s).

Using beam-specific WUS does require the UE to monitor for multiple WUS, for example up to 64, and hence does add complexity. However, this can be optimised, for example, by utilising a base sequence and with a beam-specific cyclic shift. Alternatively, different roots of a Zadoff-Chu sequence may be utilised for each beam, or the beam index may be utilised to initialise the scrambling sequence used for the WUS.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) (RTM) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally 45 referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ or “including” does not exclude the presence of other elements.

1. A method of paging early indication in a wireless communications system, comprising:
transmitting a wake-up signal (PEI) before each paging occasion by the base station;
receiving the wake-up signal by UE, wherein the wake-up signal indicates information of UE groups/sub-groups for paging before the next paging occasion.

2. The method of claim 1, wherein the wake-up signal is sequence-based.

3. The method of claim 1, wherein the wake-up signal is multiplexed with SSB or SIB1, or PDCCH signals.

4. The method of claim 1, where in the wake-up signal comprised in a wake up signal burst.

5. The method of claim 4, wherein the wake up signal burst is transmitted a predefined time offset prior to a paging occasion to which the wake up signal burst relates.

6. The method of claim 5, wherein the time offset is defined as the time from the end of the wake up signal burst to the start of a paging occasion to which the wake up signal burst relates.

7. The method of claim 1, wherein at least two of the wake up signals of the burst are transmitted continuously in adjacent symbols.

8. The method of claim 1, wherein the wake up signals of at least two beams are the same.

9. The method of claim 1, wherein the wake up signals of at least two beams are different.

10. The method of claim 1, wherein the at least one wake up signal comprises a base sequence with a cyclic shift dependent on the beam.

11. The method of claim 1, wherein the burst of wake up signals is transmitted in at least two slots.

12. The method of claim 1, wherein the burst of wake up signals does not overlap with control regions of slots in which the burst of wake up signals is transmitted.

13. A paging early indication method performed by a user equipment (UE), comprising:
configured, by a base station, with a wake-up signal before a next paging occasion (PO), wherein PEI indicates information of UE groups/sub-groups for paging before the next PO.

14. (canceled)

15. A UE configured to perform a method of paging early indication in a wireless communications system, comprising:
receiving a wake-up signal by the UE, wherein the wake-up signal indicates information of UE groups/sub-groups for paging before the next paging occasion.

16. The UE of claim 15, wherein the wake-up signal is sequence-based.

17. The UE of claim 15, wherein the wake-up signal is multiplexed with SSB or SIB1, or PDCCH signals.

18. The UE of claim 15, where in the wake-up signal comprised in a wake up signal burst.

19. The UE of claim 15, wherein the wake up signal burst is transmitted a predefined time offset prior to a paging occasion to which the wake up signal burst relates.

20. The UE of claim 19, wherein the time offset is defined as the time from the end of the wake up signal burst to the start of a paging occasion to which the wake up signal burst relates.

21. The UE of claim 15, wherein at least two of the wake up signals of the burst are transmitted continuously in adjacent symbols.
